(19) United States
(12) Patent Application Publication
(10) Pub. No.: US 2008/0176784 A1
(43) Pub. Date: Jul. 24, 2008

(54) Fabric Conditioning Compositions

(76) Inventors: Ann Clowes, Bebington (GB); John Hubbard, Bebington (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 10/556,646

(22) PCT Filed: Apr. 9, 2004
(86) PCT No.: PCT/EP04/03992

§ 371 Date: Mar. 27, 2007

(30) Foreign Application Priority Data
May 13, 2003 (GB) 0310974.1

(51) Int. Cl. C11D 1/835; C11D 1/62; C11D 1/72

(52) U.S. Cl. 510/524; 510/521

(57) ABSTRACT

A fabric conditioning composition comprises (a) an ester linked quaternary ammonium fabric softening material; and (b) a nonionic material represented by formula (I) wherein R and R′ are independently selected from C₁ to C₁₅ optionally substituted alkyl, alkenyl, hydroxyalkyl and benzyl groups and the combined number of carbons in R and R′ is from 7 to 16, n is from 1 to 9 and a is 2 or 3. The nonionic material is used to improve high temperature storage stability of the composition.

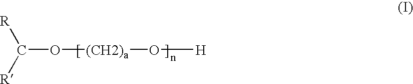

### FIELD OF THE INVENTION

The present invention relates to fabric conditioning compositions. More specifically, the present invention relates to fabric conditioning compositions comprising specific nonionic surfactants which provide excellent high temperature stability.

### BACKGROUND AND PRIOR ART

Fabric treatment compositions for treatment of fabrics during a laundry operation are well known. They are typically divided into the classes of domestic or industrial compositions, main-wash or rinse cycle compositions and cleaning or conditioning/softening compositions.

Fabric conditioning compositions typically comprise a fabric conditioning agent, such as a fabric softening material, at a level of about 1 to less than about 10% by weight in which case the composition is considered to be dilute or semi-concentrated, or from more than about 10 to about 30% by weight, in which case the composition is considered to be concentrated.

It has hitherto been known that so-called concentrated compositions are particularly prone to instability, such as phase-separation, flocculation, gelling, pearlescence etc, upon storage,

At elevated temperature storage, instability often manifests itself as pearlescence or as an irreversible thickening of the composition to the point that it may no longer be pourable. This is clearly undesirable to consumers.

It was generally considered that such problems did not exist for so-called dilute compositions.

In particular, it was conventional understood and believed that the level of components typically known to induce instability, such as perfumes, nonionic surfactants and quaternary ammonium fabric softening materials, was sufficiently low that their destabilising influence was negligible.

Storage stability at elevated temperatures has previously been addressed in various ways. WO-A1-99/50378 discloses a fabric softening agent comprising from 1 to 8% of a quaternary ammonium fabric conditioning compound, a stabilising agent and a fatty alcohol. The stabilising agent is preferably a primary or secondary alkoxylated alcohol comprising 10 or more moles of alkylene oxide.

The present inventors have found that, while stability upon storage at an elevated temperature of 37° C. is desirable, it can be achieved, for dilute compositions at least, without significant difficulty. However, stability at even higher temperatures, e.g. 41° C. or 45° C. or even 50° C., as can be experienced for extended periods in certain environments, is disproportionately more difficult to achieve.

This problem is exacerbated when the composition comprises an ester-linked quaternary ammonium fabric softening material and is further complicated when the material has one or more fully saturated alkyl chains.

However, it is desirable to use ester-linked compounds due to their inherent biodegradability and to use substantially fully saturated quaternary ammonium fabric softening compounds due to their excellent softening capabilities and because they are more stable to oxidative degradation (which can lead to malodour generation) than partially saturated or fully unsaturated quaternary ammonium softening compounds.

Of the types of ester-linked quaternary ammonium materials known, it is desirable to use those based on triethanolamine which produce at least some mono-ester linked component and at least some tri-ester linked component since the raw material has a low melting temperature which enables the manufacturing process of the composition to occur at low temperatures. This reduces difficulties associated with high temperature handling, transport and processing of the raw material and compositions produced therefrom.

### OBJECTS OF THE INVENTION

The present invention seeks to address one or more of the above-mentioned problems, and/or to give one or more of the above-mentioned benefits desired by consumers.

### SUMMARY OF THE INVENTION

Thus, according to the present invention there is provided a fabric conditioning composition comprising:

(a) an ester-linked quaternary ammonium fabric softening material; and

(b) a nonionic material represented by formula (I):

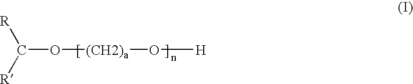

wherein R and R′ are independently selected from C₁ to C₁₅ optionally substituted alkyl, alkenyl, hydroxyalkyl and benzyl groups and the combined number of carbons in R and R′ is from 7 to 16, n is from 1 to 9 and a is 2 or 3.

In the context of the present invention, it is to be understood that n relates to the average degree of alkoxylation in any given sample.

According to a further aspect of the present invention, there is provided the use of a compound of formula (I) in a fabric conditioning composition to improve the elevated temperature storage stability of the fabric conditioning composition.

In the context of the present invention, the term “comprising” means “including” or “consisting of”. That is the steps, components, ingredients, or features to which the term “comprising” refers are not exhaustive.

### DETAILED DESCRIPTION OF THE INVENTION

The compositions of the present invention are preferably rinse conditioner compositions, more preferably aqueous rinse conditioner compositions for use in the rinse cycle of a domestic laundry process.

### Nonionic Material

The compositions of the invention comprise a nonionic material of formula (I):

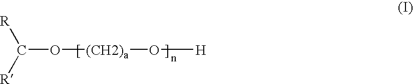

wherein R and R′ are independently selected from C₁ to C₁₅ optionally substituted alkyl, alkenyl, hydroxyalkyl and benzyl groups and the combined number of carbons in R and R′ is from 7 to 16, n is from 1 to 9 and a is 2 or 3.

Preferably the total number of carbons in R and R′ is from 8 to 15, more preferably 10 to 15, most preferably 11 to 15.

Preferably n is from 2 to 8, more preferably from 2 to 6, most preferably from 2 to 5, e.g. from 2 to 4.

Suitable materials of this class include Tergitol 15-S-3, ex Union Carbide (a mixture of linear C11-C15 secondary alcohols reacted with 3 moles of ethylene oxide); Lutensol TO3, ex BASF (a saturated nonionic surfactant based on C13 branched alcohols, with 3 moles of ethylene oxide); KX-NS12030, 14030 and Softanol 30, ex Nippon Shokubai (a mixture of secondary alcohols ethoxylated with 3 moles of ethylene oxide); Ethylan CD802, ex Across Chemicals (a synthetic branched chain alcohol reacted with 2 moles of ethylene oxide); Chemal 2EH-2, ex Chemax (a polyethyleneoxy, 2-ethylhexyl ether reacted with 2 moles of ethylene oxide); Remcopal 273, ex Atochem and Synperonic 10/3, ex ICI (both being mixtures of branched and linear C10 alcohols reacted with 3 moles of ethylene oxide); and Prox-onic 2EHA, ex Protex (a 2-ethylhexyl ether reacted with 2 moles of ethylene oxide).

It is particularly preferred that the weight ratio of quaternary ammonium material to nonionic surfactant is in the range from 1:10 to 100:1, more preferably 1:1 to 75:1, even more preferably from 1.5:1 to 50:1, most preferably 2:1 to 10:1

### Other Nonionic Surfactants

Although not essential, other nonionic surfactants may be present in the compositions. Suitable nonionic surfactants of this type can be represented by the general formula:

R—Y—(C₂H₄O)_{z}—C₂H₄OH

where R is selected from the group consisting of primary, secondary and branched chain alkyl and/or acyl hydrocarbyl groups; primary, secondary and branched chain alkenyl hydrocarbyl groups; and primary, secondary and branched chain alkenyl-substituted phenolic hydrocarbyl groups; the hydrocarbyl groups having a chain length of from 8 to about 25, Y is:

—O—, —C(O)O—, —C(O)N(R— or —C(O)N(R)R—

in which R has the meaning given above or can be hydrogen; and Z is 10 or more.

It is preferred that the level of such nonionic materials is low in the compositions of the invention because nonionic surfactants of this type can have a destabilising influence on the compositions, particularly upon storage at very high temperatures.

### Quaternary Ammonium Fabric Softening Material

The fabric conditioning material used in the compositions of the present invention comprises one or more quaternary ammonium materials which are ester-linked. Preferably the quaternary ammonium material comprises at least one mono-ester linked component and at least one tri-ester linked component.

By mono-, di- and tri-ester linked components, it is meant that the quaternary ammonium softening material comprises, respectively, a quaternary ammonium compound comprising a single ester-link with a fatty hydrocarbyl chain attached thereto, a quaternary ammonium compound comprising two ester-links each of which has a fatty hydrocarbyl chain attached thereto, and a quaternary ammonium compound comprising three ester-links each of which has a fatty hydrocarbyl chain attached thereto.

Below is shown typical levels of mono-, di- and tri-ester components in a fabric softening material used in the compositions of the invention.

The level of the mono-ester linked component of the quaternary ammonium material used in the compositions of the invention is preferably between 8 and 40% by weight, based on the total weight of the raw material in which the quaternary ammonium material is supplied.

The level of the tri-ester linked component is preferably between 20 and 50% based on the total weight of the raw material in which the quaternary ammonium material is supplied.

Preferably, the average chain length of the alkyl or alkenyl group is at least C₁₄, more preferably at least C₁₆. Most preferably at least half of the chains have a length of C₁₈.

It is generally preferred if the alkyl or alkenyl chains are predominantly linear.

A preferred ester-linked quaternary ammonium cationic softening material suitable for use in the invention is represented by the formula:

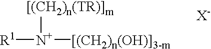

wherein each R is independently selected from a C₅-₃₅ alkyl or alkenyl group, R¹ represents a C₁₋₄ alkyl or hydroxyalkyl group or a C₂₋₄ alkenyl group,

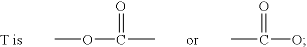

n is O or an integer selected from 1 to 4, m is 1, 2 or 3 and denotes the number of moieties to which it refers that pend directly from the N atom, and X⁻ is an anionic group, such as halides or alkyl sulphates, e.g. chloride, methyl sulphate or ethyl sulphate.

Especially preferred materials within this class are di-alkyl and di-alkenyl esters of triethanol ammonium methyl sulphate. Commercial examples of compounds within this formula are Tetranyl AHT-1 (di-hardened tallowyl ester of triethanol ammonium methyl sulphate 85% active), L1/90 (partially hardened tallow ester of triethanol ammonium methyl sulphate 90% active), and L5/90 (palm ester of triethanol ammonium methyl sulphate 90% active), all ex Kao corporation), Rewoquat WE18 and WE20 (both are partially hardened tallow ester of triethanol ammonium methyl sulphate 90% active), both ex Goldschmidt Corporation and Stepantex VK-90 (partially hardened tallow ester of triethanol ammonium methyl sulphate 90% active), ex Stepan Company).

A second group of cationic fabric softening compounds suitable for use in the invention is represented by formula:

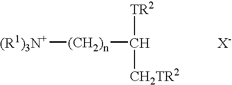

wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined above.

Preferred materials of this class such as 1,2 bis[tallowoyloxy]-3-trimethylammonium propane chloride and 1,2-bis[oleyloxy]-3-trimethylammonium propane chloride and their method of preparation are, for example, described in U.S. Pat. No. 4,137,180 (Lever Brothers), incorporated herein. A third group of cationic fabric softening compounds suitable for use in the invention is represented by formula:

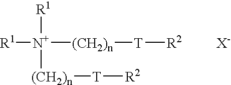

wherein each R¹ group is independently selected from C₁₋₄ alkyl, or C₂₋₄ alkenyl groups; and wherein each R² group is independently selected from C₈₋₂₈ alkyl or alkenyl groups; n is 0 or an integer from 1 to 5 and T and X⁻ are as defined above.

A preferred material of this class is di(tallowoyloxyethyl)-dimethyl ammonium chloride.

Iodine Value of the Parent Fatty Acyl group or Acid

The iodine value of the parent fatty acyl compound or acid from which the quaternary ammonium fabric softening material is formed is preferably from 0 to 120, preferably from 0 to 95, more preferably from 0 to 60. It is particularly preferred that the iodine value of the parent fatty acid or acyl group from which the quaternary ammonium fabric softening material is formed is from 0 to 25, more preferably from 0 to 10, most preferably from 0 to 5, e.g. 0 to 4 or even 0 to 2. That is, it is preferred that the alkyl or alkenyl chains are substantially fully saturated.

The iodine value, referred to above, represents the mean iodine value of the parent fatty acyl compounds or fatty acids of all of the quaternary ammonium materials present.

In the context of the present invention, iodine value of the parent fatty acyl compound or acid from which the fabric softening material formed, is defined as the number of grams of iodine which react with 100 grams of the compound.

The method for calculating the iodine value is as described in WO-A1-01/04254.

The quaternary ammonium fabric softening material is preferably present in an amount from 1 to 80% by weight based on the total weight of the composition, more preferably 1.5 to 60% by weight, most preferably 1.7 to 40% by weight, e.g. 2-25% by weight.

### Fatty Complexing Agent

It is especially preferred that the compositions of the present invention comprise a fatty complexing agent.

Especially suitable fatty complexing agents include fatty alcohols and fatty acids. Of these, fatty alcohols are most preferred.

Preferred fatty acids include hardened tallow fatty acid (available under the tradename Pristerene, ex Uniqema).

Preferred fatty alcohols include hardened tallow alcohol, available as Stenol and Hydrenol (ex Cognis), and Laurex CS (ex Albright and Wilson) and behenyl alcohol, available as Lanette 22 (ex Henkel).

The fatty complexing agent is preferably present in an amount from 0.01 to 15% by weight based on the total weight of the composition. More preferably, the fatty component is present in an amount of from 0.1 to 10%, most preferably from 0.2 to 5%, e.g. 0.3 to 4% by weight.

If the quaternary ammonium material comprises mono-, di- and tri- ester components, it is preferred that the weight ratio of the mono-ester component of the quaternary ammonium fabric softening material to the fatty complexing agent is preferably from 5:1 to 1:5, more preferably 4:1 to 1:4, most preferably 3:1 to 1:3, e.g. 2:1 to 1:2.

The method for calculating the mono-ester linked component of the quaternary ammonium material is as described in WO-A1-03/022970.

If the fatty complexing agent is a fatty alcohol it may also act as a co-active softener.

### Perfume

The compositions of the invention preferably comprise one or more perfumes.

It is well known that perfume is provided as a mixture of various components.

It is preferred that at least a quarter (by weight) or more, preferably a half or more of the perfume components have a ClogP of 2.0 or more, more preferably 3.0 or more, most preferably 4.5 or more, e.g. 10 or more.

Suitable perfumes having a ClogP of 3 or more are disclosed in U.S. Pat. No. 5,500,137.

ClogP is calculated using the “ClogP” program (calculation of hydrophobicities as logP (oil/water)) version 4.01, available from Daylight Chemical Information Systems Inc of Irvine Calif., USA.

The perfume is preferably present in an amount from 0.01 to 10% by weight, more preferably 0.05 to 5% by weight, most preferably 0.1 to 4.0% by weight, e.g. 0.2 to 0.6% by weight based on the total weight of the composition.

### Liquid Carrier

The liquid carrier employed in the instant compositions is preferably water due to its low cost relative availability, safety, and environmental compatibility. The level of water in the liquid carrier is preferably more than about 50%, more preferably more than about 80%, most preferably more than about 85%, by weight of the carrier. The level of liquid carrier is preferably greater than about 50%, more preferably greater than about 65%, most preferably greater than about 70% by weight, based on the total weight of the composition. Mixtures of water and a low molecular weight, e.g. <100, organic solvent, e.g. a lower alcohol such as ethanol, propanol, isopropanol or butanol are useful as the carrier liquid. Low molecular weight alcohols including monohydric, dihydric (glycol, etc.) trihydric (glycerol, etc.), and polyhydric (polyols) alcohols are also suitable carriers for use in the compositions of the present invention.

### Other Co-Active Softeners

Co-active softeners for the cationic surfactant may also be incorporated in an amount from 0.01 to 20% by weight, more preferably 0.05 to 10%, based on the total weight of the composition. Preferred co-active softeners include fatty esters, and fatty N-oxides.

Preferred fatty esters include fatty monoesters, such as glycerol monostearate. If GMS is present, then it is preferred that the level of GMS in the composition, is from 0.01 to 10 wt %, based on the total weight of the composition.

The co-active softener may also comprise an oily sugar derivative. Suitable oily sugar derivatives, their methods of manufacture and their preferred amounts are described in WO-A1-01/46361 on page 5 line 16 to page 11 line 20, incorporated herein.

### Polymeric Viscosity Control Agents

It is useful, though not essential, if the compositions comprise one or more polymeric viscosity control agents. Suitable polymeric polymeric viscosity control agents include nonionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

Nonionic and/or cationic polymers are preferably present in an amount of 0.005 to 5 wt %, more preferably 0.01 to 4 wt %, most preferably 0.015 to 2 wt %, e.g. 0.02 to 0.08 wt %, based on the total weight of the composition.

### Electrolytes

An electrolyte may be present in the composition.

Preferred electrolyte include salts of multi-valent anions such as sulphate is particularly preferred. Preferred counter ions for this anion included alkaline earth metals, ammonium or alkalimetals.

Particularly preferred are alkalimetal cations or ammonium. Typically preferred are sodium, potassium or ammonium salts. Sodium sulphate is particularly preferred.

It is preferred that the salt of the multivalent anion is substantially water soluble. Preferably, the salt of the multivalent anion has a solubility in excess of 1 gram per litre, preferably in excess of 25 grams per litre.

The electrolyte may comprise a salt of a univalent anion. It is preferred that the salt of the univalent anion comprises an alkali metal or alkaline earth metal salt. It is particularly preferred that the cation is sodium, potassium or ammonium. The univalent anion may be any suitable univalent anion. It is preferably an inorganic anion, and is preferably a halide, most preferably chloride.

There may be more than one salt of a univalent anion present. Particularly preferred are calcium chloride, sodium chloride, ammonium halide, rare earth halides, such as lanthanum chloride and alkali metal salts of organic acids such as sodium acetate and sodium benzoate.

Preferably, the total weight of electrolyte present is from 0.5-3.0%, more preferably 1.0-2.0%, most preferably 1.0-1.5% by weight, based on the total weight of the composition.

The salt of the univalent anion is preferably substantially water soluble. Preferably, it has a solubility in excess of 1 gram per litre, more preferably in excess of 20 grams per litre.

### Further Optional Ingredients

Other optional nonionic softeners, bactericides, soil-releases agents may also be incorporated in the compositions of the invention.

The compositions may also contain one or more optional ingredients conventionally included in fabric conditioning compositions such as pH buffering agents, perfume carriers, fluorescers, colourants, hydrotropes, antifoaming agents, antiredeposition agents, polyelectrolytes, enzymes, optical brightening agents, anti-shrinking agents, anti-wrinkle agents, anti-spotting agents, antioxidants, sunscreens, anti-corrosion agents, drape imparting agents, anti-static agents, anti-mould agents, ironing aids and dyes.

### Product Form

At ambient temperature, the product comprises a liquid, more preferably an aqueous liquid, most preferably an aqueous dispersion of the quaternary ammonium softening material.

### Product Use

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

It is also possible, though less desirable, for the compositions of the present invention to be used in industrial laundry operations, e.g. as a finishing agent for softening new clothes prior to sale to consumers.

### Preparation

The compositions of the invention may be prepared according to any suitable method.

In a first preferred method, the quaternary ammonium material, nonionic material and perfume are heated together until a co-melt is formed. Water is then heated and the co-melt is added to water with stirring. The mixture is then allowed to cool. In an alternative method, the perfume can be added to the mixture after the co-melt is formed, e.g. at any time during the cooling stage.

### EXAMPLES

The invention will now be illustrated by the following non-limiting examples. Further modifications will be apparent to the person skilled in the art.

All values are % by weight of the active ingredient unless stated otherwise.

Samples A to J were prepared in a standard 31 rig with a Janke Kunkel mill using the following process:

The DEQA, fatty alcohol and nonionic material (if present) were co-melted and then added to water at 65° C. over 2 minutes with agitation (200 rpm). Mixing was continued for a further 10 minutes and then preservative and dye added. The resulting mixture was removed from heat and perfume added with mixing and over 5 minutes during cooling. The polymer was then added.

TABLE 1

| | A | B | C | D | E | F |
|---|---|---|---|---|---|---|
| DEQA (1) | 4.98 | 4.98 | 4.98 | 4.98 | 4.98 | 4.98 |
| Fatty | 0.42 | 0.42 | 0.42 | 0.42 | 0.42 | 0.42 |
| alcohol (2) | | | | | | |
| Perfume | 0.34 | 0.34 | 0.34 | 0.34 | 0.34 | 0.34 |
| Dye | 0.001 | 0.001 | 0.001 | 0.001 | 0.001 | 0.001 |
| Polymer (3) | 0.03 | 0.03 | 0.03 | 0.03 | 0.03 | 0.03 |
| Nonionic (4) | — | 2.0 | — | — | — | — |
| Nonionic (5) | — | — | 2.0 | — | — | — |
| Nonionic (6) | — | — | — | 2.0 | — | — |
| Nonionic (7) | — | — | — | — | 2.0 | — |
| Nonionic (8) | — | — | — | — | — | 2.0 |
| Preservative | 0.08 | 0.08 | 0.08 | 0.08 | 0.08 | 0.08 |
| Water | To 100 | To 100 | To 100 | To 100 | To 100 | To 100 |

(1) di(acyloxyethyl)(2-hydroxyethyl) methyl ammonium methyl sulphate where the acyl group is derived from fully hydrogenated tallow.
(2) Stenol 1618L, ex Cognis
(3) Natrasol 331, ex Hercules
(4) Tergitol 15-S-3, ex Union Carbide
(5) Tergitol 15-S-5, ex Union Carbide
(6) Tergitol 15-S-7, ex Union Carbide
(7) Lutensol TO3, ex BASF
(8) Coco 5 EO (available as Genapol C050, ex Clariant)

TABLE 2

| | G | H | I | J | K |
|---|---|---|---|---|---|
| DEQA (1) | 4.98 | 4.98 | 4.98 | 4.98 | 4.98 |
| Fatty | 0.42 | 0.42 | 0.42 | 0.42 | 0.42 |
| alcohol (2) | | | | | |
| Perfume | 0.34 | 0.34 | 0.34 | 0.34 | 0.34 |
| Dye | 0.001 | 0.001 | 0.001 | 0.001 | 0.001 |
| Polymer (3) | 0.03 | 0.03 | 0.03 | 0.03 | 0.03 |
| Nonionic (9) | 2.0 | — | — | — | — |
| Nonionic (4) | — | 0.5 | 1.0 | — | — |
| Nonionic (7) | — | — | — | 0.5 | 1.0 |
| Preservative | 0.08 | 0.08 | 0.08 | 0.08 | 0.08 |
| Water | To 100 | To 100 | To 100 | To 100 | To 100 |

(1) as above
(2) as above
(3) as above
(4) as above
(7) as above
(9) Coco 20EO (Genapol C-200, ex Clariant)

TABLE 3

| | L | M |
|---|---|---|
| DEQA (1) | 4.98 | 4.98 |
| Fatty alcohol (2) | 0.42 | 0.42 |
| Perfume | 0.34 | 0.34 |
| Dye | 0.002 | 0.002 |
| Polymer (3) | 0.03 | 0.03 |
| Nonionic (10) | 2.0 | — |
| Nonionic (11) | — | 2.0 |
| Water | To 100 | To 100 |

(1) as above
(2) as above
(3) as above
(10) polyethylene glycol monodecyl ether (KX-NS12030, ex Nippon Shokubai)
(11) polyethylene glycol tetradodecyl ether (KX-NS14030, ex Nippon Shokubai)

### Example 1

### Viscosity Evaluation

Viscosity was measured upon storage at various temperatures. Measurements were made at 106s⁻¹ at ambient temperature using a Haake Rotoviscometer RV20 NV Bob and Cup.

Sample A was stored at 37° C., 41° C., 45° C. and 50° C. Viscosity data is given in the following table:

TABLE 4

| | |
|---|---|
| Temp | Time (weeks) |

| (° C.) | 0 | 4 | 6 | 8 | 10 | 12 |
|---|---|---|---|---|---|---|
| 37 | 117.7 | 133.8 | 110 | 92 | 94 | 82 |
| 41 | 117.7 | 124.8 | 123 | 78 | 79 | 72 |
| 45 | 117.7 | 130.7 | 78 | 87 | Gelled | — |
| 50 | 117.7 | 95.7 | 88 | 127 | Gelled | — |

The results demonstrate that storage stability was particularly problematic at very high temperatures.

Samples B to M were stored at 45° C. and 50° C. The viscosity results are given in the following table. In the following tables, “G” denotes gelled, “P” denotes pearlesced, “PS” denotes phase separation, “F” denotes flocculated, and “S” denotes solid.

TABLE 5
storage at 45° C.

| Sam- | Time (weeks) | | | | | | | | | |
|---|---|---|---|---|---|---|---|---|---|---|
| ple | 0 | 2 | 4 | 6 | 7 | 8 | 9 | 10 | 11 | 12 |
| B | 111 | — | 123 | 57 | — | 58 | — | 61 | — | 79 |
| C | 60 | 13 | 8 | P | — | — | — | — | — | — |
| D | 6 | — | 15 | 16 | — | F | — | — | — | — |
| E | 150 | — | 156 | 193 | — | 109 | — | 92 | — | 122 |
| F | 10 | — | 7 | 6 | — | 16 | — | P | — | — |
| G | 10 | — | 7 | 5 | — | 16 | — | P | — | — |
| H | 102 | 118 | 95 | 89 | — | 78 | — | — | S | — |
| I | 100 | 114 | 87 | 67 | — | 78 | — | — | 123 | — |
| J | 101 | 83 | 98 | — | 99 | — | 135 | — | — | — |
| K | 124 | 107 | 99 | — | 93 | — | 124 | | | |
| L | 109 | — | 97 | 89 | — | 72 | — | — | — | 124 |
| M | 156 | — | 132 | 144 | — | 171 | — | — | — | 202 |

TABLE 6
storage at 50° C.

| Sam- | Time (weeks) | | | | | | | | | |
|---|---|---|---|---|---|---|---|---|---|---|
| ple | 0 | 2 | 4 | 6 | 7 | 8 | 9 | 10 | 11 | 12 |
| B | 111 | — | 83 | 64 | — | 47 | — | 71 | Gel | — |
| C | 60 | 9 | PS | — | — | — | — | — | — | — |
| D | 6 | — | 15 | F | S | — | — | — | — | — |
| E | 150 | — | 111 | 97 | — | 62 | — | 83 | — | G |
| F | 10 | — | 6 | 5 | — | PS | | | | |
| G | 10 | — | 6 | 5 | — | PS | — | — | — | — |
| H | 102 | 72 | 43 | 46 | — | 88 | — | — | S | — |
| I | 100 | 47 | 41 | — | — | 63 | — | — | S | — |
| J | 101 | 82 | 82 | — | 124 | — | S | — | — | — |
| K | 124 | 80 | 102 | — | 103 | — | 124 | — | — | — |
| L | 109 | — | 82 | 59 | — | 48 | — | — | — | PS |
| M | 156 | — | 117 | 135 | — | 198 | — | — | — | PS |

1. A fabric conditioning composition in the form of an aqueous dispersion comprising:
(a) an ester-linked quaternary ammonium fabric softening material selected from 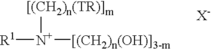
wherein each R is independently selected from a C₅₋₃₅ alkyl or alkenyl group, R¹ represents a C₁₋₄ alkyl or hydroxyalkyl group or a C₂₋₄ alkenyl group, 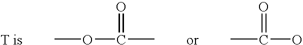
n is O or an integer selected from 1 to 4, m is 1, 2 or 3 and denotes the number of moieties to which it refers that pend directly from the N atom, and X⁻ is an anionic group; 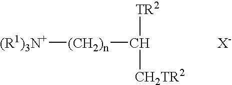
wherein each R¹ group is independently selected from C₁₋₄ alkyl, hydroxyalkyl or C₂₋₄ alkenyl groups; and wherein each R² group is independently selected from C₈₋₂₈ alkyl or alkenyl groups; n is 0 or an integer from 1 to 5 and T and X⁻ are as defined above, and 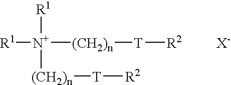
wherein each R¹ group is independently selected from C₁₋₄ alkyl, or C₂₋₄ alkenyl groups; and wherein each R² group is independently selected from C₈₋₂₈ alkyl or alkenyl groups; n is 0 or an integer from 1 to 5 and T and X⁻ are as defined above;
(b) A nonionic material represented by formula (I): 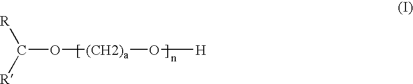
wherein R and R′ are independently selected from C₁ to C₁₅ optionally substituted alkyl, alkenyl, hydroxyalkyl and benzyl groups and the combined number of carbons in R and R′ is from 7 to 16, n is from 1 to 6 and a is 2 or 3.

2. A composition as claimed in claim 1 wherein, in the nonionic material, n is from 2 to 5.

3. A composition as claimed in claim 2 wherein, in the nonionic material, n is from 2 to 4.

4. A composition as claimed claim 1, wherein, in the nonionic material, the total number of carbons, R+R′, is from8to15.

5. A composition as claimed in claim 1 wherein, in the nonionic material, the total number of carbons, R+R′, is from 10 to 15.

6. A composition as claimed in claim 1 wherein, in the nonionic material, the total number of carbons, R+R′, is from 11 to 15.

7. The use of a nonionic material of formula: 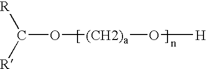
wherein R and R′ are independently selected from C₁ to C₁₅ optionally substituted alkyl, alkenyl, hydroxyalkyl, and benzyl groups and the combined number of carbons in R and R′ is from 7to 16, n is from 1 to6and a is 2 or 3
in a fabric conditioning composition comprising an ester linked quaternary ammonium fabric softening material selected from: 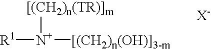
wherein each R is independently selected from a C₅₋₃₅ alkyl or alkenyl group, R¹ represents a C₁₋₄ alkyl or hydroxyalkyl group or a C₂₋₄ alkenyl group, 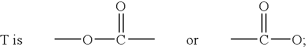
n is O or an integer selected from 1 to 4, m is 1, 2 or 3 and denotes the number of moieties to which it refers that pend directly from the N atom, and X⁻ is an anionic group; 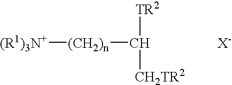
wherein each R¹ group is independently selected from C₂₋₄ alkyl groups; and wherein each R² group is independently selected from C₈₋₂₈ alkyl or alkenyl groups; n is 0 or an integer from 1 to 5 and T and X⁻ are as defined above, and 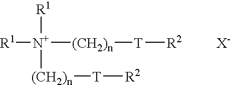
wherein each R¹ group is independently selected from C₁₋₄ alkyl, or C₂₋₄ alkenyl groups; and wherein each R² group is independently selected from C₈₋₂₈ alkyl or alkenyl groups; n is 0 or an integer from 1 to 5 and T and X⁻ are as defined above;
to improve the elevated temperature storage stability of the fabric conditioning composition.
